(19) United States
(12) Patent Application Publication
(10) Pub. No.: US 2026/0165553 A1
(43) Pub. Date: Jun. 18, 2026

(54) CLEANING DEVICE AND PREPARATION METHOD THEREOF

(71) Applicant: SHENZHEN HONGJIANTOU TECHNOLOGY CO., LTD., SHENZHEN (CN)

(72) Inventor: Zhinan ZHANG, SHENZHEN (CN)

(73) Assignee: SHENZHEN HONGJIANTOU TECHNOLOGY CO., LTD., SHENZHEN (CN)

(21) Appl. No.: 19/531,580

(22) Filed: Feb. 5, 2026

(51) Int. Cl. A47L 13/42; A47L 1/09; A47L 13/11; B29C 45/14; B29C 45/16; B29L 31/00

(52) U.S. Cl. CPC A47L 13/42; A47L 1/09; A47L 13/11; B29C 45/1671; B29C 45/14336; B29C 2045/1659; B29L 2031/74

(57) ABSTRACT

A cleaning device includes: an inner bracket including a squeegee head bracket and a handle bracket fastened to the squeegee head bracket; and an outer casing covering the inner bracket and being fastened to an exterior of the inner bracket. The outer casing includes a squeegee head portion and a handle portion, the squeegee head portion includes a squeegee head body and a squeegee portion disposed at a front end of the squeegee head body, a thickness of the squeegee portion is less than a thickness of the squeegee head body, and the squeegee portion is flexibly deformable. The squeegee head body covers an exterior of the squeegee head bracket, and the handle portion covers an exterior of the handle bracket. A hook-shaped structure is formed at a tail of the handle portion. The cleaning device is convenient to store.

### TECHNICAL FIELD

The present disclosure relates to the field of cleaning tools, and in particular, relates to a hand-operated cleaning device for cleaning smooth surfaces including glass, and a preparation method thereof.

### BACKGROUND

Currently, a common handheld cleaning device typically employs a modular assembly structure: An independent handle is configured to mechanically clamp and fasten a rubber squeegee blade via a metal connector or a clamping frame. This design relies on assembling of a plurality of separate components, which not only complicates a preparation process and increases costs but also makes it inconvenient for a user to replace the squeegee blade.

More importantly, local rigid clamping of the squeegee blade by a metal part is likely to cause uneven pressure distribution on the squeegee blade. As a result, during glass cleaning, it is difficult to maintain uniform pressure along a blade edge, easily leaving streaks or water marks and compromising cleaning effectiveness. In addition, an exposed metal component has a risk of rust in a humid environment, and a hard edge of the exposed metal component may accidentally scratch a glass surface during operation, presenting clear shortcomings in terms of safety and durability.

In summary, it is difficult for an existing cleaning device to balance wiping effect, use safety, production efficiency, and durability in structural design, leaving considerable room for improvement in overall user experience.

### SUMMARY OF PRESENT INVENTION

An objective of the present disclosure is to provide a cleaning device with a stable structure and a reliable connection and preparation method thereof.

To achieve the foregoing objective, according to a first aspect, the present disclosure provides a cleaning device, including an inner bracket and an outer casing. The inner bracket includes a squeegee head bracket and a handle bracket, and the squeegee head bracket is fastened to the handle bracket. The outer casing covers and is fastened to an exterior of the inner bracket, and includes a squeegee head portion and a handle portion. The squeegee head portion includes a squeegee head body and a squeegee portion disposed at a front end of the squeegee head body, a thickness of the squeegee portion is less than a thickness of the squeegee head body, and the squeegee portion is flexibly deformable; and the squeegee head body covers an exterior of the squeegee head bracket, and the handle portion covers an exterior of the handle bracket. A hook-shaped structure is formed at a tail of the handle portion.

According to a second aspect, the present disclosure provides a preparation method for a cleaning device, including: placing a squeegee head bracket into a first mold, and injection-molding a handle bracket connected to the squeegee head bracket to form an inner bracket; placing the inner bracket into a second mold, and forming an outer casing outside the inner bracket, where a part that covers the squeegee head bracket is formed into a squeegee head portion (including the squeegee head body and a flexibly deformable squeegee portion), a part that covers the handle bracket is formed into a handle portion, and a hook-shaped structure is formed at a tail of the handle portion.

### BRIEF DESCRIPTION OF THE DRAWINGS

To describe the technical solutions in the embodiments of the present disclosure more clearly, the following briefly describes the accompanying drawings required for describing the embodiments. Apparently, the accompanying drawings in the following description show merely some embodiments of the present disclosure, and a person of ordinary skill in the art may still derive other drawings from these accompanying drawings without creative efforts.

FIG. 1 is a schematic structural diagram of an inner bracket according to an embodiment of the present disclosure;

FIG. 2 is an exploded structural diagram of an inner bracket according to an embodiment of the present disclosure;

FIG. 3 is a schematic structural diagram of an outer casing according to an embodiment of the present disclosure;

FIG. 4 is a schematic structural diagram of another outer casing according to an embodiment of the present disclosure;

FIG. 5 is a schematic structural diagram of a squeegee head bracket according to an embodiment of the present disclosure;

FIG. 6 is a partially-enlarged schematic structural diagram of a squeegee head bracket according to an embodiment of the present disclosure;

FIG. 7 is a schematic structural diagram of another squeegee head bracket according to an embodiment of the present disclosure;

FIG. 8 is a schematic structural diagram of another squeegee head bracket according to an embodiment of the present disclosure;

FIG. 9 is a schematic structural diagram of a first plastic bracket according to an embodiment of the present disclosure;

FIG. 10 is a schematic structural diagram of a second plastic bracket according to an embodiment of the present disclosure;

FIG. 11 is a schematic structural diagram of a handle bracket according to an embodiment of the present disclosure;

FIG. 12 is a schematic structural diagram of another handle bracket according to an embodiment of the present disclosure;

FIG. 13 is a schematic structural diagram of another handle bracket according to an embodiment of the present disclosure;

FIG. 14 is a partially-enlarged structural diagram of a handle bracket according to an embodiment of the present disclosure;

FIG. 15 is a schematic structural diagram of another handle bracket according to an embodiment of the present disclosure;

FIG. 16 is a schematic structural diagram of another handle bracket according to an embodiment of the present disclosure;

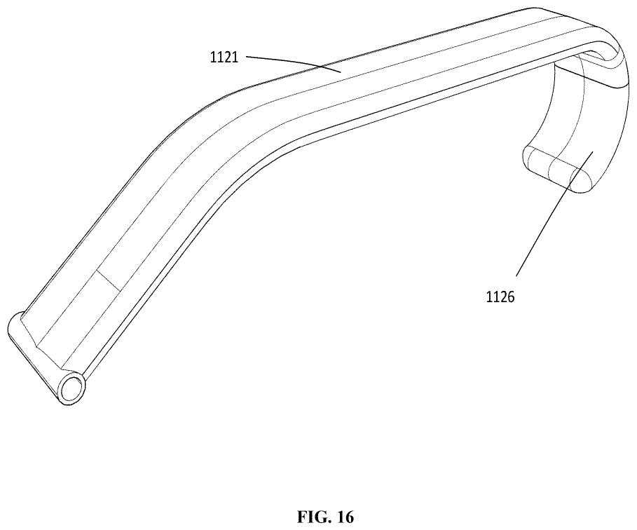

FIG. 17 is a schematic flowchart of a preparation method according to an embodiment of the present disclosure;

FIG. 18 is a schematic flowchart of another preparation method according to an embodiment of the present disclosure; and

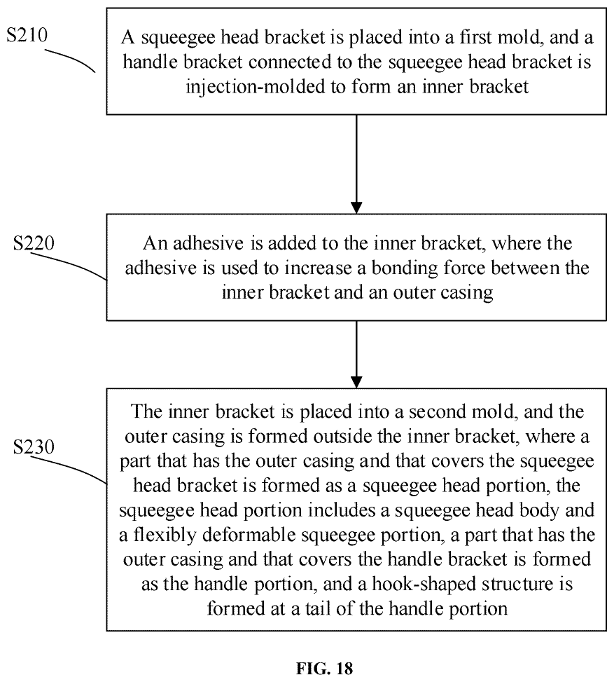

FIG. 19 is a schematic flowchart of another preparation method according to an embodiment of the present disclosure.

110: inner bracket;
111: squeegee head bracket;
1111: squeegee head bracket body;
1112: squeegee head connecting portion;
112: handle bracket;
1121: handle bracket body;
11211: first plastic bracket;
11212: second plastic bracket;
1122: handle connecting portion;
1123: hollow structure;
1124: anti-slip structure;
1125: first bent structure;
1126: extension bracket;
120: outer casing;
121: squeegee head portion;
1211: squeegee head body;
1212: squeegee portion;
122: handle portion; and
123: hook-shaped structure.

### DETAILED DESCRIPTION OF THE EMBODIMENTS

In the following description, specific details such as a specific system structure and a technology are provided for description instead of limitation, to thoroughly understand embodiments of the present disclosure. However, those skilled in the art should understand that the present disclosure may also be implemented in other embodiments without these specific details. In other cases, detailed descriptions of a well-known system, apparatus, circuit, and method are omitted to avoid unnecessary details interfering with the description of the present disclosure.

The terms “first” and “second” of embodiments of the present disclosure are only used to distinguish between related technical features and do not indicate a sequence.

The technical solutions of the present disclosure are described in detail below with reference to the accompanying drawings and specific embodiments. It should be understood that the specific embodiments described herein are merely intended to explain the present disclosure, rather than to limit the present disclosure. All other embodiments obtained by those skilled in the art based on the embodiments of the present disclosure without creative efforts shall fall within the protection scope of the present disclosure.

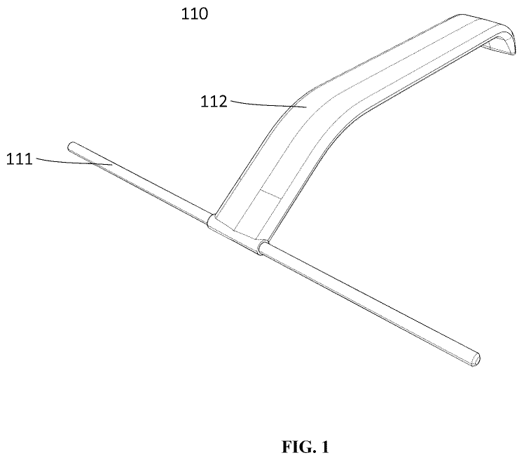

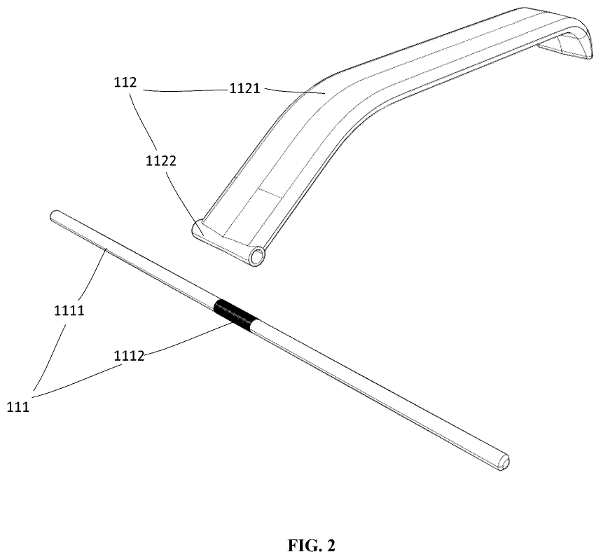

Refer to FIG. 1 to FIG. 4. Embodiments of the present disclosure provide a cleaning device, mainly including an inner bracket 110 and an outer casing 120 that covers and is fastened to an exterior of the inner bracket 110.

The inner bracket 110, as a core support structure, includes a squeegee head bracket 111 and a handle bracket 112. In an embodiment, the squeegee head bracket 111 is a metal part (for example, stainless steel or aluminum alloy) to provide necessary rigidity and strength for a squeegee head portion. In an embodiment, the handle bracket 112 is a plastic injection-molded part to achieve lightweighting and facilitate formation of a complex structure. The squeegee head bracket 111 and the handle bracket 112 are fastened as described below to form an integrated support framework.

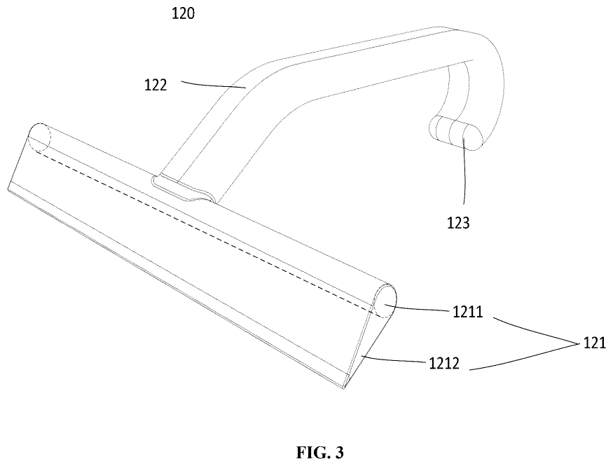

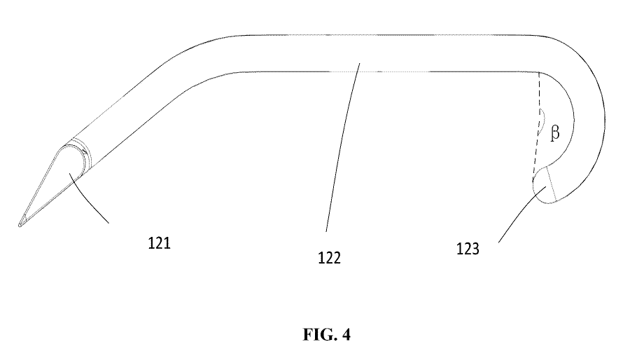

Refer to FIG. 3 and FIG. 4. In an embodiment, the outer casing 120 may be made of elastic or soft materials including rubber, thermoplastic polyurethane (TPU), or silicone. The outer casing 120 includes a squeegee head portion 121 and a handle portion 122. The squeegee head portion 121 further includes a squeegee head body 1211 and a squeegee portion 1212 disposed at a front end of the squeegee head body 1211. The squeegee portion 1212 is designed to have a thickness less than that of the squeegee head body 1211. In addition, with no inner bracket support ahead, the squeegee portion 1212 is flexibly deformable within a large range, thereby closely attaching to a surface being cleaned (including glass), and improving wiping effect and sealing performance. The squeegee head body 1211 covers an exterior of the squeegee head bracket 111, while the handle portion 122 covers an exterior of the handle bracket 112. At a tail of the handle portion 122, a hook-shaped structure 123 is integrally formed for hanging and storing the cleaning device.

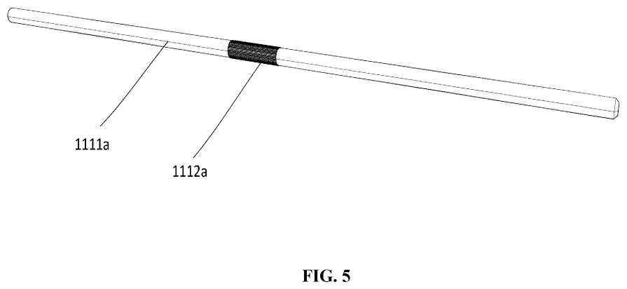

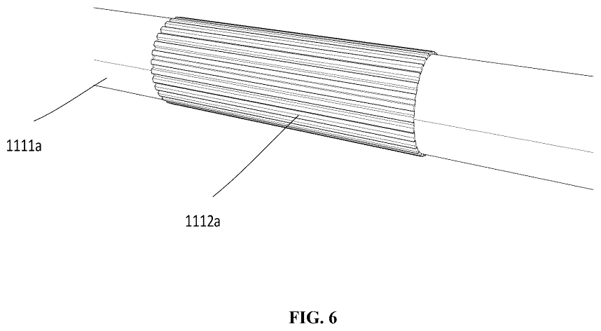

In an embodiment, as shown in FIG. 5 and FIG. 6, the squeegee head bracket 111 includes a squeegee head bracket body 1111a and a squeegee head connecting portion 1112a located at a middle part of the squeegee head bracket body 1111a. Correspondingly, the handle bracket 112 includes a handle bracket body 1121 and a handle connecting portion 1122 formed at an end of the handle bracket body 1121. The squeegee head bracket 111 and the handle bracket 112 are fastened via the squeegee head connecting portion 1112a and the handle connecting portion 1122. In a preferred connection manner, during preparation, the metal squeegee head connecting portion 1112a is placed in a mold, and the plastic handle connecting portion 1122 is directly injection-molded to cover an exterior of the squeegee head connecting portion 1112a, thereby forming a high-strength integrated connection.

To further prevent relative rotation and enhance connection reliability between the plastic handle connecting portion 1122 and the squeegee head connecting portion 1112a, the squeegee head connecting portion 1112a is designed with a non-circular cross-sectional structure. More preferably, as shown in FIG. 5 and FIG. 6, a surface of the squeegee head connecting portion 1112a may be disposed as a knurled structure to increase a contact area and mechanical interlocking force with over-molded plastic.

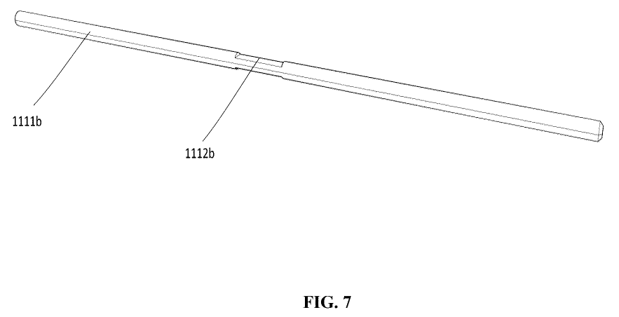

As shown in FIG. 7, in another embodiment provided in the present disclosure, the squeegee head bracket 111 includes a squeegee head bracket body 1111b and a squeegee head connecting portion 1112b located at a middle part of the squeegee head bracket body 1111b. The squeegee head bracket body 1111b has a cylindrical structure, and the squeegee head connecting portion 1112b has a groove structure processed into the middle part of the squeegee head bracket body 1111b.

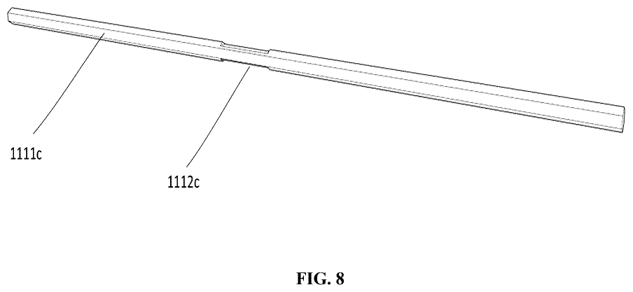

As shown in FIG. 8, in another embodiment provided in the present disclosure, the squeegee head bracket 111 includes a squeegee head bracket body 1111c and a squeegee head connecting portion 1112c located at a middle part of the squeegee head bracket body 1111c. The squeegee head bracket body 1111c has a columnar structure with a hexagonal cross-section, and the squeegee head connecting portion 1112c has a groove structure processed into the middle part of the squeegee head bracket body 1111c.

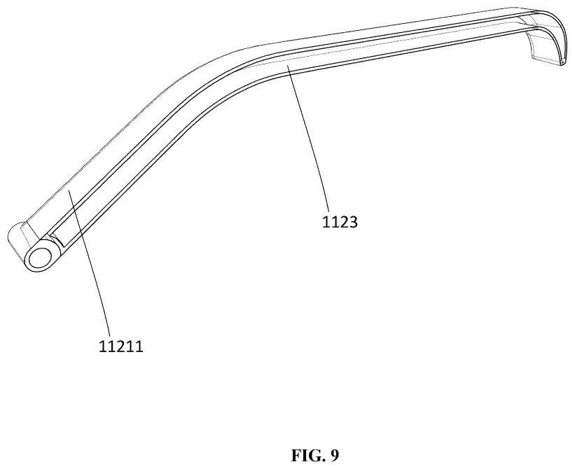

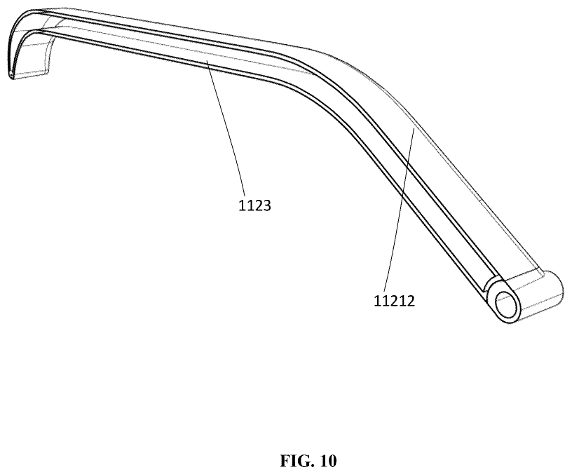

As shown in FIG. 9 and FIG. 10, regarding a structure of the handle bracket 112, the handle bracket 112 may be designed as a hollow structure 1123 to reduce overall weight. To achieve this hollow structure, the handle bracket 112 may include a first plastic bracket 11211 and a second plastic bracket 11212 that are joined together.

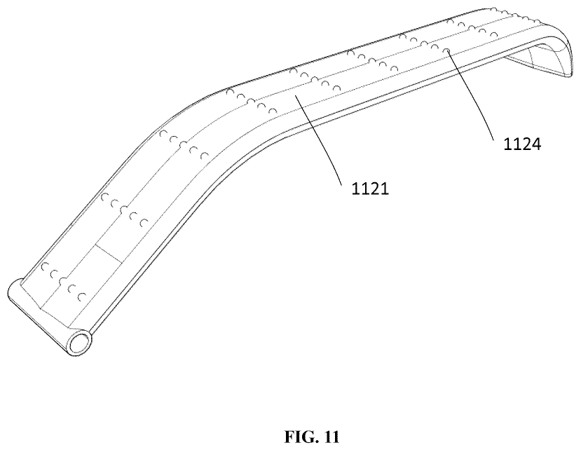

In addition, as shown in FIG. 11, an anti-slip structure 1124 including a pit, a protrusion, or a mesh pattern may be disposed on the surface of the inner bracket 110 (particularly the handle bracket 112) to further restrict relative movement through mechanical interlocking.

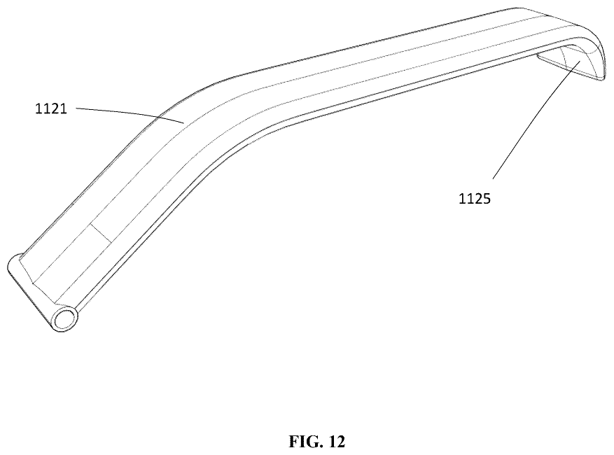

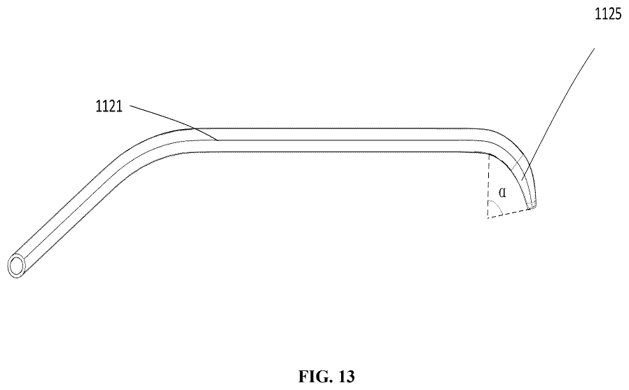

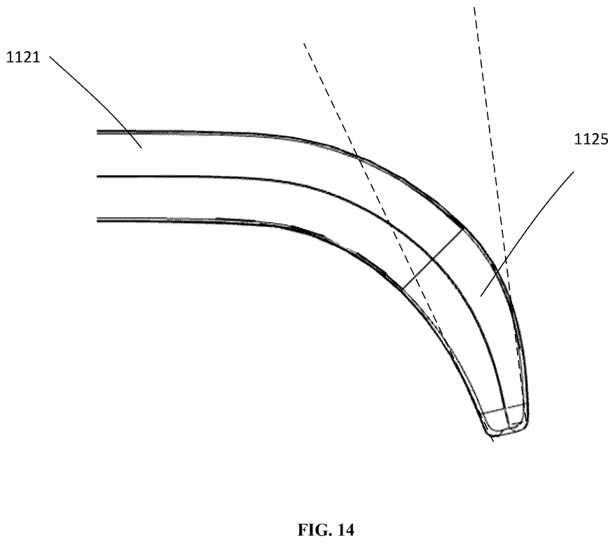

Refer to FIG. 12 to FIG. 14. In another embodiment, a first bent structure 1125 may be formed at a tail of the handle bracket 112. A bending curvature α of the first bent structure 1125 is preferably less than 90°. This pre-bending design gives the tail of the handle bracket 112 a bending tendency matching the final hook-shaped structure 123 of the outer casing, helping to optimize stress distribution. As shown in FIG. 12, a cross-section of the first bent structure 1125 can gradually decrease from a root toward a tail end. A bending curvature β of the hook-shaped structure 123 on the outer casing is typically greater than a curvature α of the first bent structure 1125. In addition, a tail of the hook-shaped structure 123, particularly a part with a bending curvature exceeding 90° from a tail end of a handle, may be designed to be thinner or made of a more elastic material, making it an elastically deformable structure.

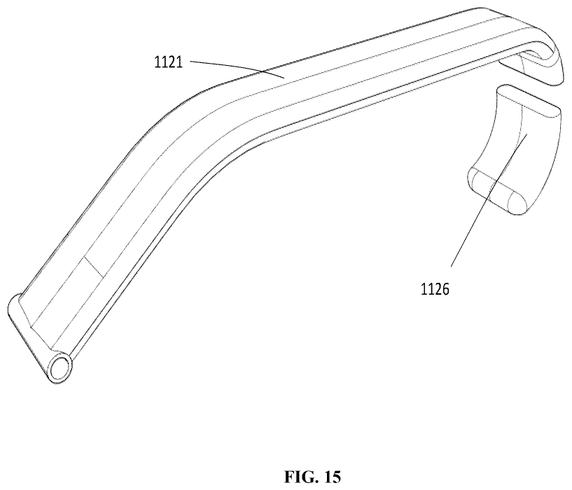

As shown in FIG. 15, to extend a handle length or achieve other functions (including cleaning a high place), an extension bracket 1126 may be connected to the tail of the handle bracket 112. The extension bracket 1126 may be a flexible bracket or a rigid bracket (including a rigid plastic rod). When the extension bracket 1126 is a rigid bracket, a non-rigid connection manner including a hinged or sleeved connection, may be used between the extension bracket 1126 and the handle bracket 112, allowing relative movement.

To increase a bonding force between the inner bracket 110 and the outer casing 120, preventing separation or relative sliding, an adhesive layer (not shown in the figures) may be provided between the inner bracket 110 and the outer casing 120. The adhesive layer may be formed by spraying or dipping an adhesive followed by curing, and preferably covers most of the surface area of the inner bracket 110.

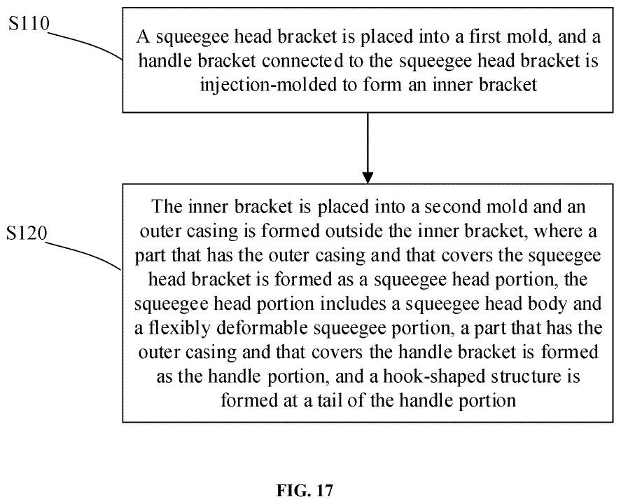

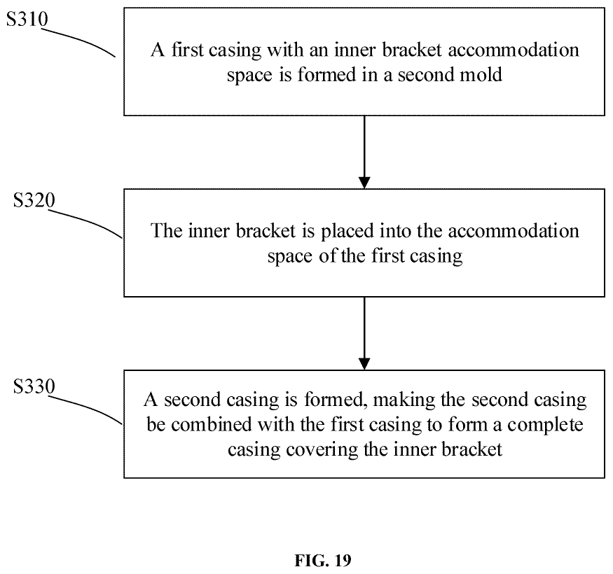

The present disclosure further provides a preparation method for the cleaning device, explained below with reference to the flowcharts shown in FIG. 17 and FIG. 19.

An inner bracket molding step (S110) is performed. The metal squeegee head bracket 111 is placed into a cavity of a first mold. Through an injection molding process, the plastic handle bracket 112 is injection-molded on the squeegee head connecting portion 1112 of the squeegee head bracket 111 and at a predetermined position. The injection material fills up the mold and covers the squeegee head connecting portion 1112, forming the handle connecting portion 1122, thereby obtaining a stably connected and integrated inner bracket 110.

An outer casing molding step (S120) is performed. The processed inner bracket 110 is placed into a second mold and the outer casing 120 is formed outside the inner bracket. This step can be further detailed as follows:

In step S310, a first casing (for example, a lower half casing) is formed. In the second mold, a first casing having an accommodation space matching a shape of the inner bracket 110 is formed by placing a pre-pressed adhesive strip or injecting a molding compound. For example, a pre-pressed adhesive strip can be placed on the lower mold, and the lower mold is closed to form the first casing.

In step S320, the inner bracket is placed. The inner bracket 110 is precisely placed into the accommodation space of the first casing.

In step S330, a second casing (for example, an upper half casing) is formed and the second mold is closed. An adhesive strip is placed on the first casing into which the inner bracket 110 is placed (or a material is directly injected into the second mold), and then the second mold is closed to form the second casing. The second casing is combined with the first casing around the inner bracket 110, thereby forming a complete outer casing 120 that fully covers the inner bracket 110. Finally, a part covering the squeegee head bracket 111 forms the squeegee head portion 121 and the squeegee portion 1212 thereof, while the part covering the handle bracket 112 forms the handle portion 122 and the hook-shaped structure 123 at the tail of the handle portion 122.

An embodiment of the present disclosure further provides a preparation method for the cleaning device. After performing the inner bracket molding step (S210), the method further includes the following steps.

An adhesive adding step (S220) is performed. After the inner bracket 110 is cleaned, an adhesive is applied to a surface of the inner bracket 110 to increase a bonding force with a subsequently formed outer casing 120. The application manner may be brushing: A side of the inner bracket 110 is first brushed with an adhesive, and then another side of the inner bracket 110 is brushed after flipping; or dipping is performed: The entire inner bracket 110 is immersed into the adhesive and then got out. Then, a baking step can be performed to cure the adhesive.

Then, an outer casing molding step (S230) is performed. The processed inner bracket 110 is placed into a second mold and the outer casing 120 is formed outside the inner bracket. For specific steps, refer to the foregoing embodiments. Details are not described herein again.

Through the aforementioned structural design and preparation method, the cleaning device provided in the present disclosure achieves stable integration between the inner bracket and the outer casing, achieves excellent flexible fitting of the squeegee portion, and features the hook-shaped structure at the tail of the handle for convenient storage. The overall structure is simple, reliable, and durable.

A person of ordinary skill in the art may be aware that, in combination with the examples described in embodiments disclosed in this specification, units and algorithm steps may be implemented by electronic hardware or a combination of computer software and electronic hardware. Whether the functions are performed by hardware or software depends on particular applications and design constraints of the technical solutions. A person skilled in the art may use different methods to implement the described functions for each specific application, but such implementation should not be considered to be beyond the scope of the present disclosure.

The foregoing embodiments are only used to explain the technical solutions of the present disclosure, and are not intended to limit the present disclosure. Although the present disclosure is described in detail with reference to the foregoing embodiments, persons of ordinary skill in the art should understand that they can still modify the technical solutions described in the foregoing embodiments, or make equivalent substitutions on some technical features therein. These modifications or substitutions do not make the essence of the corresponding technical solutions deviate from the spirit and scope of the technical solutions in embodiments of the present disclosure, and shall fall within the protection scope of the present disclosure.

What is claimed is:

1. A cleaning device, comprising:
an inner bracket, wherein the inner bracket comprises a squeegee head bracket and a handle bracket, and the squeegee head bracket is fastened to the handle bracket; and
an outer casing, wherein the outer casing covers the inner bracket and is fastened to an exterior of the inner bracket, wherein
the outer casing comprises a squeegee head portion and a handle portion, the squeegee head portion comprises a squeegee head body and a squeegee portion disposed at a front end of the squeegee head body, a thickness of the squeegee portion is less than a thickness of the squeegee head body, and the squeegee portion is flexibly deformable; and the squeegee head body covers an exterior of the squeegee head bracket, and the handle portion covers an exterior of the handle bracket; and
a hook-shaped structure is formed at a tail of the handle portion.

2. The cleaning device according to claim 1, wherein the handle bracket is a plastic injection-molded part; and the squeegee head bracket is a metal part.

3. The cleaning device according to claim 2, wherein a handle connecting portion is formed on the handle bracket; a squeegee head connecting portion is formed on the squeegee head bracket; and the handle bracket and the squeegee head bracket are fastened via the handle connecting portion and the squeegee head connecting portion.

4. The cleaning device according to claim 3, wherein the handle connecting portion is connected to an exterior of the squeegee head connecting portion through injection molding.

5. The cleaning device according to claim 3, wherein the squeegee head connecting portion has a non-circular structure.

6. The cleaning device according to claim 5, wherein a surface of the squeegee head connecting portion has a knurled structure.

7. The cleaning device according to claim 2, wherein the handle bracket has a hollow structure.

8. The cleaning device according to claim 7, wherein the handle bracket comprises a first plastic bracket and a second plastic bracket, and the first plastic bracket and the second plastic bracket are joined together to form the hollow structure.

9. The cleaning device according to claim 2, wherein a first bent structure is formed at the tail of the handle bracket.

10. The cleaning device according to claim 9, wherein a bending curvature of the first bent structure is less than 180°.

11. The cleaning device according to claim 9, wherein a cross-section of the first bent structure gradually decreases in a direction from a handle to a tail of a bend.

12. The cleaning device according to claim 9, wherein a bending curvature of the hook-shaped structure is greater than a bending curvature of the first bent structure.

13. The cleaning device according to claim 1, wherein a tail of the hook-shaped structure has an elastically deformable structure.

14. The cleaning device according to claim 13, wherein in the hook-shaped structure, a part with a bending curvature exceeding 90° from a tail end of a handle has an elastically deformable structure.

15. The cleaning device according to claim 1, wherein an extension bracket is connected to the tail of the handle bracket.

16. The cleaning device according to claim 15, wherein the extension bracket is a flexible bracket.

17. The cleaning device according to claim 15, wherein the extension bracket is a rigid bracket, and the extension bracket is non-rigidly connected to the handle bracket.

18. The cleaning device according to claim 1, wherein an adhesive layer is further disposed between the inner bracket and the outer casing, and the adhesive layer is configured to increase a bonding force between the inner bracket and the outer casing.

19. The cleaning device according to claim 18, wherein the adhesive layer covers most of a surface area of the inner bracket.

20. The cleaning device according to claim 1, wherein an anti-slip structure is disposed on the inner bracket, and the anti-slip structure is configured to restrict relative sliding between the inner bracket and the outer casing.

21. A preparation method of a cleaning device, comprising following steps:
placing a squeegee head bracket into a first mold, and injection-molding a handle bracket connected to the squeegee head bracket to form an inner bracket; and
placing the inner bracket into a second mold, and forming an outer casing outside the inner bracket, wherein a part that is of the outer casing and that covers the squeegee head bracket is formed into a squeegee head portion, the squeegee head portion comprises a squeegee head body and a flexibly deformable squeegee portion; and a part that is of the outer casing and that covers the handle bracket is formed into a handle portion, and a hook-shaped structure is formed at a tail of the handle portion.

22. The preparation method according to claim 21, further comprising a step of adding an adhesive to the inner bracket after injection-molding the inner bracket, wherein the adhesive is used to increase a bonding force between the inner bracket and the outer casing.

23. The preparation method according to claim 22, wherein the step of adding the adhesive is brushing the adhesive, and comprises: first brushing one side of the inner bracket, and then flipping the inner bracket to brush another side of the inner bracket.

24. The preparation method according to claim 22, wherein the step of adding the adhesive is dipping the adhesive, and comprises: immersing the inner bracket in the adhesive to coat a surface of the inner bracket with the adhesive.

25. The preparation method according to claim 22, wherein after adding the adhesive, the method further comprises a step of baking the inner bracket added with the adhesive to cure the adhesive.

26. The preparation method according to claim 21, wherein the step of forming the outer casing in the second mold comprises:
forming a first casing having an inner bracket accommodation space in the second mold;
placing the inner bracket into the accommodation space of the first casing; and
forming a second casing, and combining the second casing with the first casing to form a complete outer casing covering the inner bracket.

27. The preparation method according to claim 26, wherein the step of forming the first casing comprises:
placing a pre-pressed adhesive strip into a lower mold part of the second mold, and closing the second mold to form the first casing.

28. The preparation method according to claim 26, wherein the step of forming the second casing comprises:
placing an adhesive strip on the first casing with the inner bracket placed therein, and closing the second mold to form the second casing.

29. The preparation method according to claim 26, wherein the step of forming the first casing comprises:
injecting a molding compound into a lower mold part of the second mold, and closing the second mold to form the first casing.

30. The preparation method according to claim 26, wherein the step of forming the second casing comprises: injecting a molding compound onto the first casing with the inner bracket already placed in the first casing, and closing the second mold to form the second casing.
